(19) United States
(12) Patent Application Publication
(10) Pub. No.: US 2017/0034776 A1
(43) Pub. Date: Feb. 2, 2017

(54) METHOD, APPARATUS, AND SYSTEM FOR SMART DEVICE TO ACCESS ROUTER

(71) Applicant: Xiaomi Inc., Beijing (CN)

(72) Inventors: Enxing HOU, Beijing (CN); Yi DING, Beijing (CN); Yuanbo WANG, Beijing (CN)

(21) Appl. No.: 15/220,431

(22) Filed: Jul. 27, 2016

(30) Foreign Application Priority Data
Jul. 28, 2015 (CN) 201510452197.7

(51) Int. Cl. H04W 48/20; H04W 76/06; H04W 76/04; H04W 48/16

(52) U.S. Cl. CPC H04W 48/20; H04W 48/16; H04W 76/064; H04W 76/045; H04W 84/12

(57) ABSTRACT

The present disclosure relates to a method and apparatus for a smart device to access a router. The method includes: receiving an identifier of the smart device and an SSID of a router currently accessed by the smart device; acquiring a set of SSIDs of routers corresponding to the identifier of the smart device; determining whether the router currently accessed by the smart device is an access-prohibited router according to the SSID of the router currently accessed and the set of SSIDs of routers and obtaining a determined result; and transmitting a corresponding instruction to the smart device according to the determined result.

### CROSS-REFERENCE TO RELATED APPLICATIONS

This application is based on and claims priority to Chinese Patent Application No. 201510452197.7, filed Jul. 28, 2015, the entire contents of which are incorporated herein by reference.

### TECHNICAL FIELD

The present disclosure generally relates to the field of network communications, and more particularly, to a method, an apparatus and a system for a smart device to access a router.

### BACKGROUND

A smart device provided with WiFi (wireless local area network) connectivity, when accessing a network, may broadcast a message carrying device description information of itself, and the surrounding WiFi devices may receive the broadcasted message. Such a feature is utilized by certain WiFi auxiliary devices in their connection solutions. Specifically, when a device that is accessing a network is detected, a Service Set Identifier (SSID) and a password may be sent to the device via a broadcast message, so as to facilitate a connection of the device to a designated router.

A smart device is able to access the router quickly in the above-described manner However, risk of an unauthorized user (e.g., a neighbor) connecting to the smart device exists.

### SUMMARY

According to a first aspect of the present disclosure, there is provided a method for a smart device to access a router, comprising: receiving an identifier of the smart device and an SSID of a router currently accessed by the smart device; acquiring a set of SSIDs of routers corresponding to the identifier of the smart device; determining whether the router currently accessed by the smart device is an access-prohibited router according to the SSID of the router currently accessed and the set of SSIDs of routers and obtaining a determined result; and transmitting a corresponding instruction to the smart device according to the determined result.

According to a second aspect of the present disclosure, there is provided a method for a smart device to access a router, comprising: transmitting an identifier of the smart device and an SSID of the router to a server when the smart device accesses the router, the server being configured to determine whether the router currently accessed by the smart device is an access-prohibited router and to obtain a determined result; receiving from the server a corresponding instruction generated according to the determined result; and performing a corresponding process according to the corresponding instruction.

According to a third aspect of the present disclosure, there is provided an apparatus for a smart device to access a router, comprising: a processor; and a memory for storing instructions executable by the processor, wherein the processor is configured to: receive an identifier of the smart device and an SSID of a router currently accessed by the smart device; acquire a set of SSIDs of routers corresponding to the identifier of the smart device; determine whether the router currently accessed by the smart device is an access-prohibited router according to the SSID of the router currently accessed and the set of SSIDs of routers and obtain a determined result; and transmit a corresponding instruction to the smart device according to the determined result.

According to a fourth aspect of the present disclosure, there is provided an apparatus for a smart device to access a router, comprising: a processor; and a memory for storing instructions executable by the processor, wherein the processor is configured to: transmit an identifier of the smart device and an SSID of the router to a server when the smart device accesses the router, the server being configured to determine whether the router currently accessed by the smart device is an access-prohibited router and obtain a determined result; receive from the server a corresponding instruction generated according to the determined result; and perform a corresponding process according to the corresponding instruction.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain, rather than limit, the principles of the present disclosure.

FIG. 1 is a block diagram of a system for a smart device to access a router according to an exemplary embodiment.

FIG. 2 is a flow chart of a method for a smart device to access a router according to an exemplary embodiment.

FIG. 3 is a flow chart of a method for a smart device to access a router according to an exemplary embodiment.

FIG. 4 is a flow chart of a method for a smart device to access a router according to an exemplary embodiment.

FIG. 5 is a flow chart of a method for a smart device to access a router according to an exemplary embodiment.

FIG. 6 is a block diagram of an apparatus for a smart device to access a router according to an exemplary embodiment.

FIG. 7 is a block diagram of a determination module in an apparatus for a smart device to access a router according to an exemplary embodiment.

FIG. 8 is a block diagram of a transmission module in an apparatus for a smart device to access a router according to an exemplary embodiment.

FIG. 9 is a block diagram of an apparatus for a smart device to access a router according to an exemplary embodiment.

FIG. 10 is a block diagram of a process module in the apparatus for a smart device to access a router according to an exemplary embodiment.

FIG. 11 is a block diagram of an apparatus according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

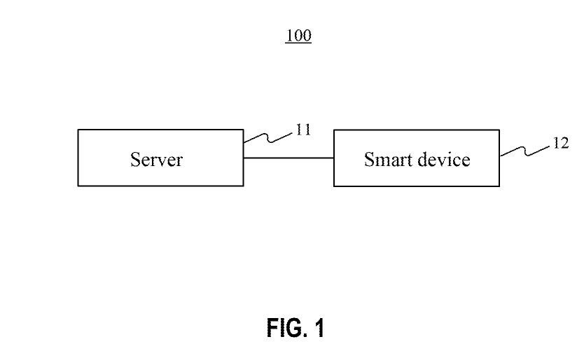

FIG. 1 is a block diagram of a system 100 for a smart device to access a router, according to an exemplary embodiment. Referring to FIG. 1, the system 100 includes a server 11 and a smart device 12. The server 11 is configured to: receive an identifier of the smart device 12 and an SSID of a router currently accessed by the smart device 12; acquire a set of SSIDs of routers corresponding to the identifier of the smart device 12; determine whether the router currently accessed by the smart device 12 is an access-prohibited router according to the SSID of the router currently accessed and the set of SSIDs of routers so as to obtain a determined result; and transmit a corresponding instruction to the smart device 12 according to the determined result.

The smart device 12 is configured to: transmit the identifier of the smart device 12 and the SSID of the router to the server 11 when the smart device 12 accesses the router; receive from the server 11 the corresponding instruction generated according to the determined result; and perform a corresponding process according to the corresponding instruction.

According to the embodiment described above, when the smart device 12 accesses the router, whether the router currently accessed by the smart device 12 is an access-prohibited router is timely determined according to the SSID of the router currently accessed and the set of SSIDs of routers corresponding to the identifier of the smart device 12. A corresponding instruction is transmitted to the smart device 12 based on the determined result for performing a corresponding process, so as to prevent the smart device 12 from continuously accessing the access-prohibited router.

For illustration purposes, an interactive process between the server 11 and the smart device 12 is described as follows.

First, the server 11 receives the identifier of the smart device 12 and the set of SSIDs of routers corresponding to the identifier of the smart device 12, and stores them correspondingly.

Next, when the smart device 12 accesses the router, the identifier of the smart device 12 and the SSID of the router are transmitted to the server 11.

Next, the server 11 receives the identifier of the smart device 12 and the SSID of the router currently accessed by the smart device 12.

Next, the server 11 acquires the set of SSIDs of routers corresponding to the identifier of the smart device 12.

Next, the server determines whether the router currently accessed by the smart device 12 is an access-prohibited router, according to the SSID of the router currently accessed and the set of SSIDs of routers, to obtain a determined result.

Next, the server 11 transmits the corresponding instruction to the smart device 12 based on the determined result.

Next, the smart device 12 receives from the server 11 the corresponding instruction generated based on the determined result.

Next, the smart device 12 performs the corresponding process according to the corresponding instruction.

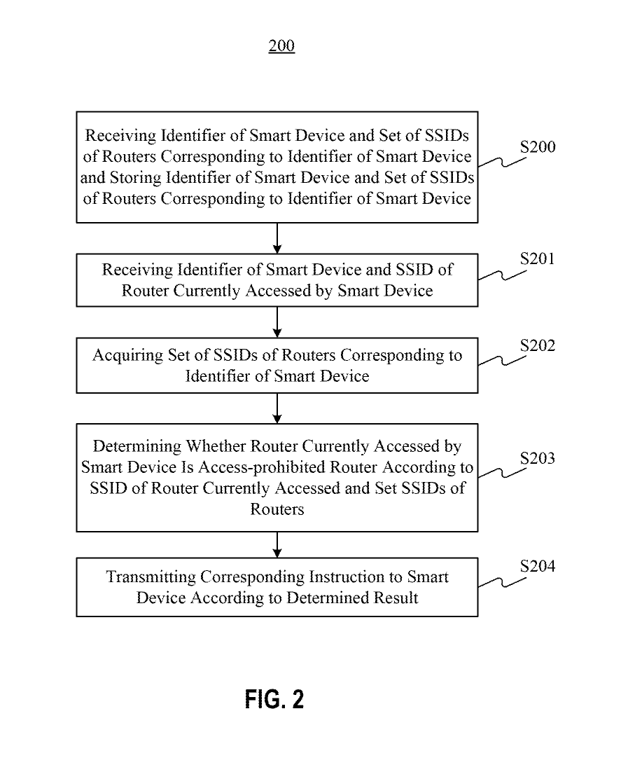

FIG. 2 is a flow chart of a method 200 for a smart device to access a router according to an exemplary embodiment. Referring to FIG. 2, the method 200 for the smart device to access the router is applicable in a server or an application program. The method 200 includes following steps S200-S204.

Step S201 includes receiving an identifier of the smart device and an SSID of a router currently accessed by the smart device. Step S202 includes acquiring a set of SSIDs of routers corresponding to the identifier of the smart device. Step S203 includes determining whether the router currently accessed by the smart device is an access-prohibited router, according to the SSID of the router currently accessed and the set of SSIDs of routers, to obtain a determined result. Step S204 includes transmitting a corresponding instruction to the smart device according to the determined result.

According to the embodiment described above, when the smart device accesses the router, whether the router currently accessed by the smart device is an access-prohibited router is timely determined according to the SSID of the router currently accessed and the set of SSIDs of routers corresponding to the identifier of the smart device. A corresponding instruction is transmitted to the smart device based on the determined result for a corresponding process, so as to prevent the smart device from accessing the access-prohibited router continuously.

In an exemplary embodiment, step S203 includes:

if the set of SSIDs of routers is a set of SSIDs of access-prohibited routers and the SSID of the router currently accessed exists in the set of SSIDs of access-prohibited routers, determining the router currently accessed by the smart device as an access-prohibited router; or

if the set of SSIDs of routers is a set of SSIDs of access-prohibited routers and the SSID of the router currently accessed does not exist in the set of SSIDs of access-prohibited routers, determining the router currently accessed by the smart device as an access-permitted router.

According to the embodiment described above, the set of SSIDs of routers is a set of SSIDs of access-prohibited routers. Whether the router currently accessed by the smart device is an access-prohibited router is determined based on whether the SSID of the router currently accessed exists in the set of SSIDs of access-prohibited routers. Herein, the set of SSIDs of access-prohibited routers may be provided by a user according to actual settings.

In an exemplary embodiment, step S203 includes:

if the set of SSIDs of routers is a set of SSIDs of access-permitted routers and the SSID of the router currently accessed does not exist in the set of SSIDs of access-permitted routers, determining the router currently accessed by the smart device as an access-prohibited router; or

if the set of SSIDs of routers is a set of SSIDs of access-permitted routers and the SSID of the router currently accessed exists in the set of SSIDs of access-permitted routers, determining the router currently accessed by the smart device as an access-permitted router.

According to the embodiment described above, the set of SSIDs of routers is a set of SSIDs of access-permitted routers. Whether the router currently accessed by the smart device is an access-prohibited router is determined based on whether the SSID of the router currently accessed exists in the set of SSIDs of access-permitted routers. Herein, the set of SSIDs of access-permitted routers may be determined based on an user's actual situation.

In an exemplary embodiment, step S204 includes:

if the router currently accessed by the smart device is an access-prohibited router, transmitting a reset instruction to the smart device, the reset instruction instructing the smart device to resume a state of being not connected with any router; or

if the router currently accessed by the smart device is an access-prohibited router, transmitting a disconnect instruction to the smart device, the disconnect instruction instructing the smart device to disconnect from the router currently accessed; or

if the router currently accessed by the smart device is an access-prohibited router, transmitting a reconnect instruction to the smart device, the reconnect instruction instructing the smart device to disconnect from the router currently accessed and try to reconnect with another router; or

if the router currently accessed by the smart device is an access-permitted router, transmitting a connection holding instruction to the smart device, the connection holding instruction instructing the smart device to hold in a state of being connected with the router currently accessed.

According to the embodiment described above, a corresponding process may be performed according to the determined result. If the router currently accessed by the smart device is an access-prohibited router, a connection with the current router may be disconnected timely. Otherwise, the connection with the current router may be held.

In an embodiment, as shown in FIG. 2, the method 200 may further include a following step prior to the step S201.

Step S200 includes receiving the identifier of the smart device and the set of SSIDs of routers corresponding to the identifier of the smart device, and storing them correspondingly. The identifier of the smart device and the set of SSIDs of routers may be received from the smart device, or received from an application program installed in the smart device after the application program is configured by the user.

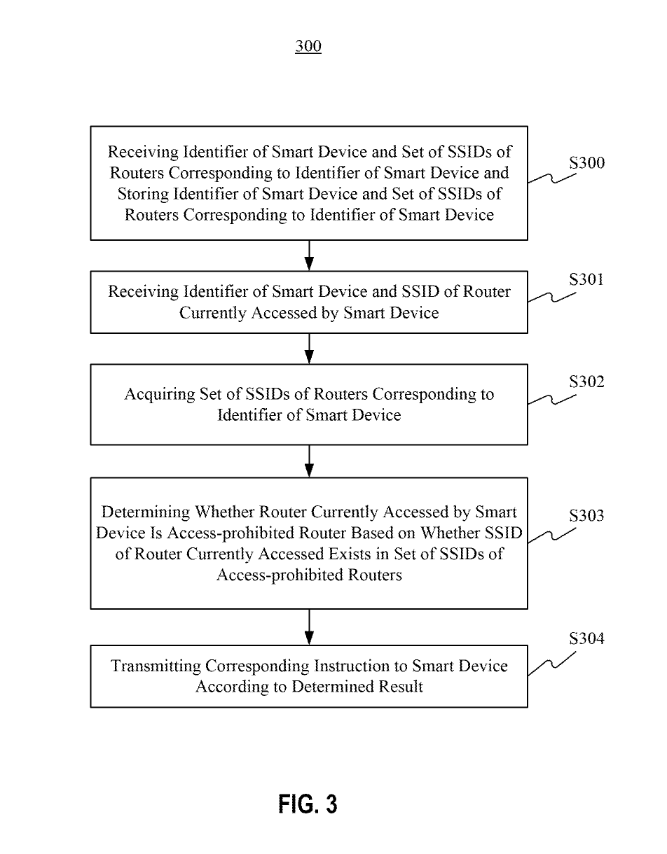

FIG. 3 is a flow chart of a method 300 for a smart device to access a router according to an exemplary embodiment. Referring to FIG. 3, the method 300 for a smart device to access a router is applicable in a server or an application program, and includes steps S300-S304 as follows.

Step S300 includes receiving an identifier of the smart device and a set of SSIDs of routers corresponding to the identifier of the smart device, and storing them correspondingly.

Step S301 includes receiving the identifier of the smart device and an SSID of a router currently accessed by the smart device.

S302 includes acquiring the set of SSIDs of routers corresponding to the identifier of the smart device.

S303 includes, if the set of SSIDs of routers is a set of SSIDs of access-prohibited routers, determining whether the router currently accessed by the smart device is an access-prohibited router based on whether the SSID of the router currently accessed exists in the set of SSIDs of access-prohibited routers. The step may include: if the set of SSIDs of routers is a set of SSIDs of access-prohibited routers and the SSID of the router currently accessed exists in the set of SSIDs of access-prohibited routers, determining the router currently accessed by the smart device as an access-prohibited router; or if the set of SSIDs of routers is a set of SSIDs of access-prohibited routers and the SSID of the router currently accessed does not exist in the set of SSIDs of access-prohibited routers, determining the router currently accessed by the smart device as an access-permitted router.

Step S304 includes transmitting a corresponding instruction to the smart device according to the determined result.

According to the embodiment described above, when the smart device accesses the router, whether the router currently accessed by the smart device is an access-prohibited router is timely determined according to the SSID of the router currently accessed and the set of SSIDs of routers corresponding to the identifier of the smart device. A corresponding instruction is transmitted to the smart device based on the determined result for a corresponding process, so as to prevent the smart device from accessing the access-prohibited router continuously.

In an exemplary embodiment, step S304 includes:

if the router currently accessed by the smart device is an access-prohibited router, transmitting a reset instruction to the smart device, the reset instruction instructing the smart device to resume a state of being not connected with any router; or

if the router currently accessed by the smart device is an access-prohibited router, transmitting a disconnect instruction to the smart device, the disconnect instruction instructing the smart device to disconnect from the router currently accessed; or

if the router currently accessed by the smart device is an access-prohibited router, transmitting a reconnect instruction to the smart device, the reconnect instruction instructing the smart device to disconnect from the router currently accessed and try to reconnect with another router; or

if the router currently accessed by the smart device is an access-permitted router, transmitting a connection holding instruction to the smart device, the connection holding instruction instructing the smart device to hold in a state of being connected with the router currently accessed.

According to the embodiment described above, a corresponding process may be performed according to the determined result. If the router currently accessed by the smart device is an access-prohibited router, a connection with the current router may be timely disconnected. Otherwise, the connection with the current router may be held.

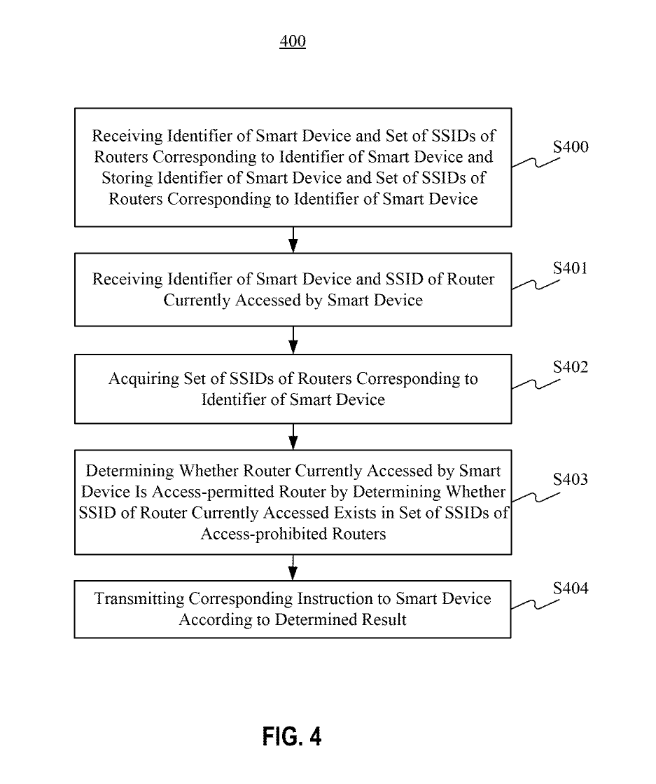

FIG. 4 is a flow chart of a method 400 for a smart device to access a router according to an exemplary embodiment. Referring to FIG. 4, the method 400 for a smart device to access a router is applicable in a server or an application program, and includes steps S400-S404 as follows.

Step S400 includes receiving an identifier of the smart device and a set of SSIDs of routers corresponding to the identifier of the smart device for a mapping storage.

Step S401 includes receiving the identifier of the smart device and an SSID of a router currently accessed by the smart device.

Step S402 includes acquiring the set of SSIDs of routers corresponding to the identifier of the smart device.

Step S403 includes, if the set of SSIDs of routers is a set of SSIDs of access-permitted routers, determining whether the router currently accessed by the smart device is an access-prohibited router based on whether the SSID of the router currently accessed exists in the set of SSIDs of access-permitted routers. Alternatively or additionally, the step may include: if the set of SSIDs of routers is a set of SSIDs of access-permitted routers and the SSID of the router currently accessed does not exist in the set of SSIDs of access-permitted routers, determining the router currently accessed by the smart device as an access-prohibited router; or if the set of SSIDs of routers is a set of SSIDs of access-permitted routers and the SSID of the router currently accessed exists in the set of SSIDs of access-permitted routers, determining the router currently accessed by the smart device as an access-permitted router.

Step S404 includes transmitting a corresponding instruction to the smart device according to the determined result.

According to the embodiment described above, when the smart device accesses the router, whether the router currently accessed by the smart device is an access-prohibited router is timely determined according to the SSID of the router currently accessed and the set of SSIDs of routers corresponding to the identifier of the smart device. A corresponding instruction is transmitted to the smart device based on the determined result for a corresponding process, so as to prevent the smart device from accessing the access-prohibited router continuously.

In an exemplary embodiment, step S404 includes:

if the router currently accessed by the smart device is an access-prohibited router, transmitting a reset instruction to the smart device, the reset instruction instructing the smart device to resume a state of being not connected with any router; or

if the router currently accessed by the smart device is an access-prohibited router, transmitting a disconnect instruction to the smart device, the disconnect instruction instructing the smart device to disconnect from the router currently accessed; or

if the router currently accessed by the smart device is an access-prohibited router, transmitting a reconnect instruction to the smart device, the reconnect instruction instructing the smart device to disconnect from the router currently accessed and try to reconnect with another router; or

if the router currently accessed by the smart device is an access-permitted router, transmitting a connection holding instruction to the smart device, the connection holding instruction instructing the smart device to hold in a state of being connected with the router currently accessed.

According to the embodiment described above, a corresponding process may be performed according to the determined result. If the router currently accessed by the smart device is an access-prohibited router, a connection with the current router may be timely disconnected. Otherwise, the connection with the current router may be held.

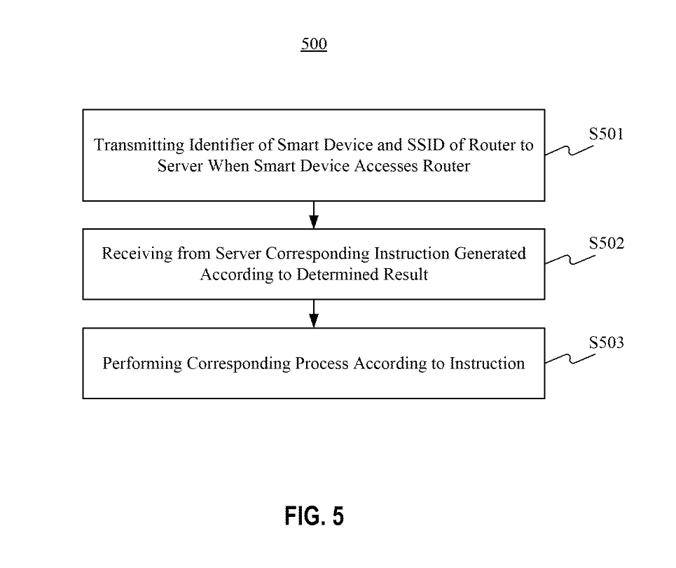

FIG. 5 is a flow chart of a method 500 for a smart device to access a router according to an exemplary embodiment. Referring to FIG. 5, the method for a smart device to access a router is applicable in a smart device or an application program, and includes steps S501-S503 as follows.

Step S501 includes transmitting an identifier of the smart device and an SSID of the router to a server when the smart device accesses the router. The server is configured to determine whether the router currently accessed by the smart device is an access-prohibited router and generate a determined result.

Step S502 includes receiving from the server a corresponding instruction generated according to the determined result.

Step S503 includes performing a corresponding process according to the corresponding instruction.

According to the embodiment described above, when the smart device accesses the router, the identifier of the smart device and the SSID of the router currently accessed are transmitted to the server, so that a corresponding instruction can be generated at the server based on the determination of whether the router currently accessed by the smart device is an access-prohibited router. A corresponding process may be performed by the smart device upon receiving the corresponding instruction, so as to prevent the smart device from accessing the access-prohibited router continuously.

Additionally or alternatively, step S503 includes:

resuming a state of being not connected with any router if the instruction is a reset instruction;

disconnecting from the router currently accessed if the instruction is a disconnect instruction;

disconnecting from the router currently accessed and trying to connect with another router if the instruction is a reconnect instruction; or

holding a connection with the router currently accessed if the instruction is a connection hold instruction.

According to the embodiment described above, if the router currently accessed by the smart device is an access-prohibited router, a connection with the current router may be timely disconnected. Otherwise, the connection with the current router may be held. Thus, the smart device is prevented from accessing the access-prohibited router continuously.

An exemplary application scenario of the disclosure will be described as following.

First, when a WiFi smart device is not connected with any router, it may broadcast a message carrying device description information of itself, which can be received by surrounding mobile terminals such as mobile phones.

Next, a prompt message of “New Device Found” is received at a terminal including an application program, such as “Smart Home” (a program used for management of WiFi smart devices), installed therein. A user of the terminal is able to select a router to be accessed and input password for the smart device according to interactive prompts, so as to facilitate the smart device to access a server.

Next, upon a successful access of the device, the terminal user may find the device in a device list of the application program “Smart Home”. After clicking on the list to enter into a device control interface, the user can control the device and check a status of the device.

Furthermore, the user may set “SSIDs of access-prohibited routers” for the device via the device control interface. Based on a list generated by the application program that scans WiFi signals around the user, the user may select SSIDs of some routers which the smart device is prohibited to access. Then, the application program transmits an identifier of the device as well as SSIDs of those access-prohibited routers to the server for storage.

If the device is reset by the user and before it is connected to a router, the device may be found in an application program by another user around the device. However, when another user connects the device with his/her own router, the server will transmit a reset instruction to the device if it is determined that, according to a device identifier and an SSID of the router received from the smart device, the device accesses an access-prohibited router.

Thus, the user's device may be prevented from being connected to neighbors' devices, or the user's device may be prevented from accessing access-prohibited routers continuously.

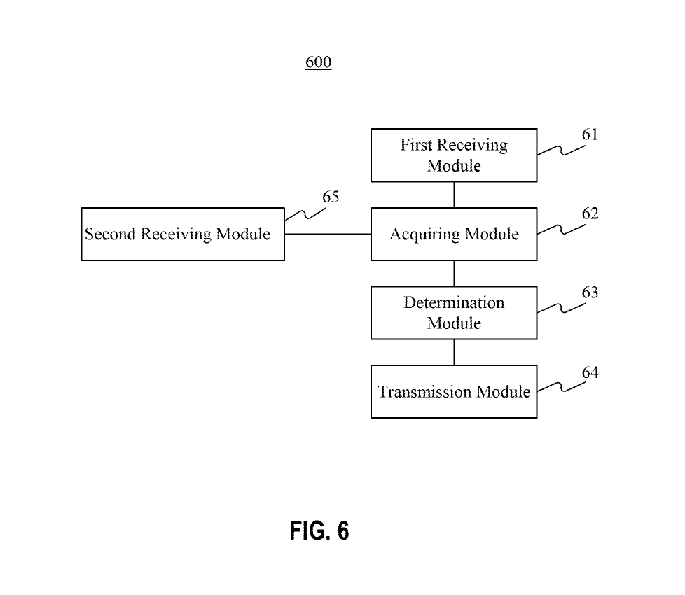

FIG. 6 is a block diagram of an apparatus 600 for a smart device to access a router according to an exemplary embodiment. Referring to FIG. 6, the apparatus 600 for a smart device to access a router includes: a first receiving module 61 configured to receive an identifier of the smart device and an SSID of a router currently accessed by the smart device; an acquiring module 62 configured to acquire a set of SSIDs of routers corresponding to the identifier of the smart device; a determination module 63 configured to determine whether the router currently accessed by the smart device is an access-prohibited router, according to the SSID of the router currently accessed and the set of SSIDs of routers, and to obtain a determined result; and a transmission module 64 configured to transmit a corresponding instruction to the smart device according to the determined result.

According to the embodiment described above, when the smart device accesses the router, whether the router currently accessed by the smart device is an access-prohibited router is timely determined according to the SSID of the router currently accessed and the set of SSIDs of routers corresponding to the identifier of the smart device. A corresponding instruction is transmitted to the smart device based on the determined result for further process, so as to prevent the smart device from accessing the access-prohibited router continuously.

In an exemplary embodiment, the apparatus 600 further includes: a second receiving module 65 configured to receive the identifier of the smart device and the set of SSIDs of routers corresponding to the identifier of the smart device for a mapping storage.

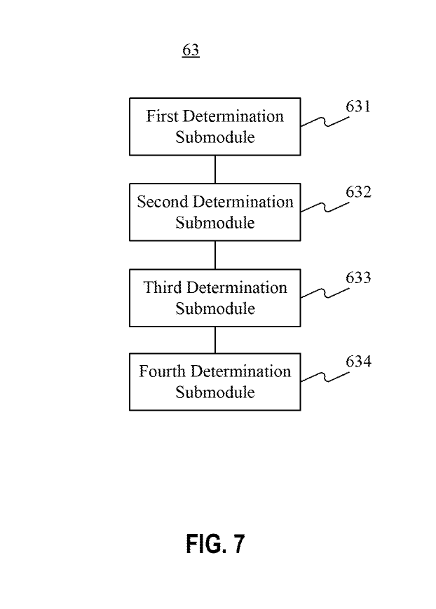

Referring to FIG. 7, in an exemplary embodiment, the determination module 63 includes: a first determination submodule 631 configured to determine the router currently accessed by the smart device as an access-prohibited router if the set of SSIDs of routers is a set of SSIDs of access-prohibited routers and the SSID of the router currently accessed exists in the set of SSIDs of access-prohibited routers; or a second determination submodule 632 configured to determine the router currently accessed by the smart device as an access-prohibited router if the set of SSIDs of routers is a set of SSIDs of access-permitted routers and the SSID of the router currently accessed does not exist in the set of SSIDs of access-permitted routers.

The determination module 63 may further include: a third determination submodule 633 configured to determine the router currently accessed by the smart device as an access-permitted router if the set of SSIDs of routers is a set of SSIDs of access-prohibited routers and the SSID of the router currently accessed does not exist in the set of SSIDs of access-prohibited routers; or a fourth determination submodule 634 configured to determine the router currently accessed by the smart device as an access-permitted router if the set of SSIDs of routers is a set of SSIDs of access-permitted routers and the SSID of the router currently accessed exists in the set of SSIDs of access-permitted routers.

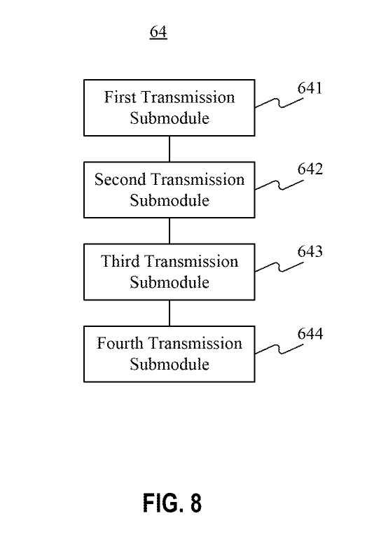

Referring to FIG. 8, the transmission module 64 includes: a first transmission submodule 641 configured to transmit a reset instruction to the smart device if the router currently accessed by the smart device is an access-prohibited router, the reset instruction instructing the smart device to resume a state of being not connected with any router; or a second transmission submodule 642 configured to transmit a disconnect instruction to the smart device if the router currently accessed by the smart device is an access-prohibited router, the disconnect instruction instructing the smart device to disconnect from the router currently accessed; or a third transmission submodule 643 configured to transmit a reconnect instruction to the smart device if the router currently accessed by the smart device is an access-prohibited router, the reconnect instruction instructing the smart device to disconnect from the router currently accessed and try to reconnect with another router.

The transmission module 64 may further include a fourth transmission submodule 644 configured to transmit a connection hold instruction to the smart device if the router currently accessed by the smart device is an access-permitted router, the connection hold instruction instructing the smart device to hold a connection with the router currently accessed.

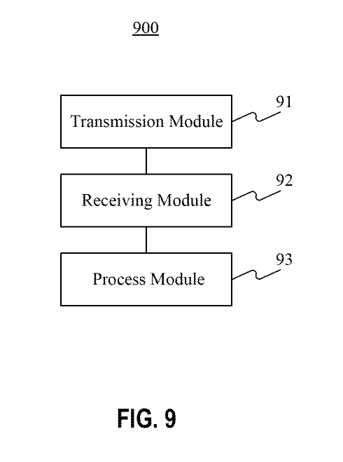

Referring to FIG. 9, an apparatus 900 for a smart device to access a router includes: a transmission module 91 configured to transmit an identifier of the smart device and an SSID of the router to a server when the smart device accesses the router, the server being configured to determine whether the router currently accessed by the smart device is an access-prohibited router and obtain a determined result; a receiving module 92 configured to receive from the server a corresponding instruction generated according to the determined result; and a process module 93 configured to perform a corresponding process according to the corresponding instruction.

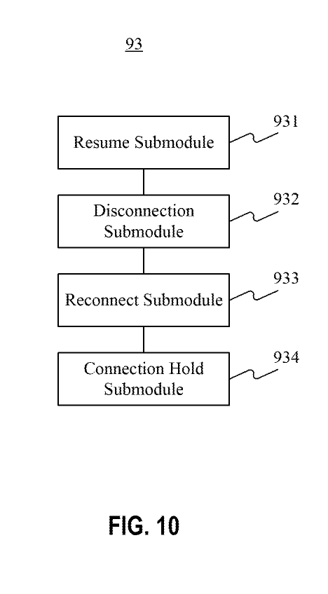

Referring to FIG. 10, the process module 93 includes: a resume submodule 931 configured to resume a state of being not connected with any router if the instruction is a reset instruction; a disconnection submodule 932 configured to disconnect from the router currently accessed if the instruction is a disconnect instruction; a reconnect submodule 933 configured to disconnect from the router currently accessed and try to connect with another router if the instruction is a reconnect instruction; or a connection hold submodule 934 configured to hold a connection with the router currently accessed if the instruction is a connection hold instruction.

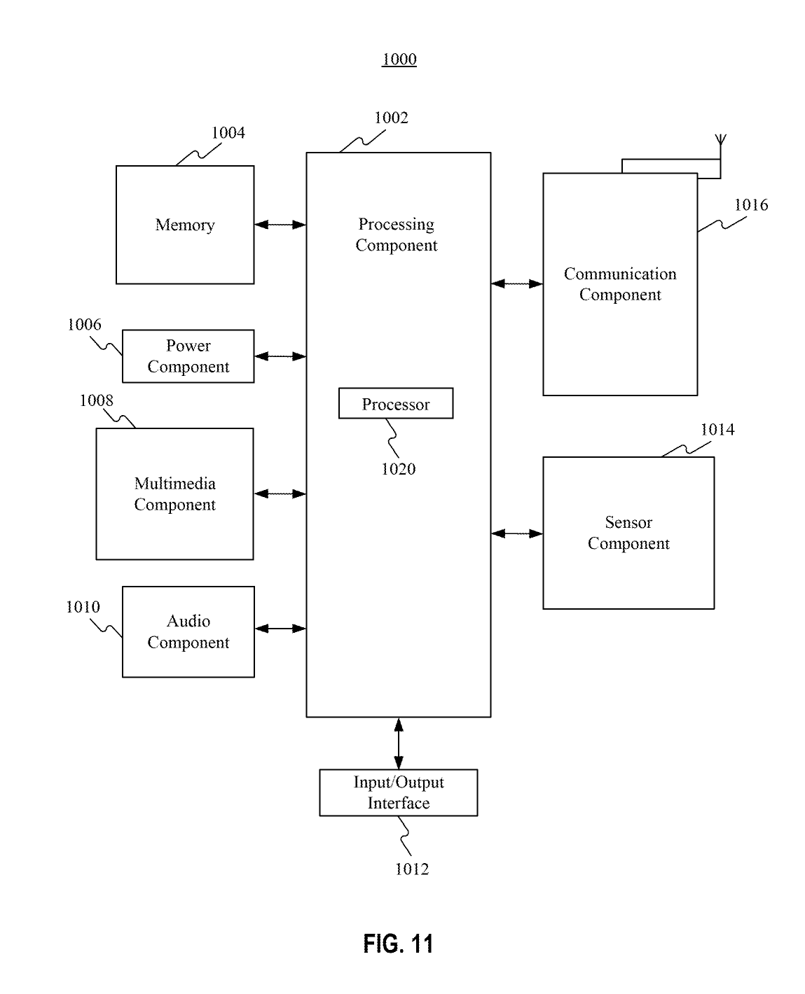

FIG. 11 is a block diagram of an apparatus 1000 according to an exemplary embodiment. The apparatus 1000 may be any of the servers or smart devices described above, and may be, e.g., a mobile phone, a computer, a digital broadcast terminal device, a messaging device, a gaming console, a tablet, a medical device, an exercise equipment, a personal digital assistant (PDA), or the like.

Referring to FIG. 11, the apparatus 1000 may include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 generally controls overall operations of the apparatus 1000, such as operations associated with display, telephone calls, data communications, camera operations, and recording operations. The processing component 1002 may include one or more processors 1020 to execute instructions to perform all or part of the steps in the above described methods. Moreover, the processing component 1002 may include one or more modules which facilitate interaction between the processing component 1002 and other components. For instance, the processing component 1002 may include a multimedia module to facilitate the interaction between the multimedia component 1008 and the processing component 1002.

The memory 1004 is configured to store various types of data to support the operation of the apparatus 1000. Examples of such data include instructions for any application or method operated on the apparatus 1000, contact data, phonebook data, messages, pictures, videos, etc. The memory 1004 may be implemented using any type of volatile or non-volatile memory apparatus or set thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or an optical disk.

The power component 1006 provides power to various components of the apparatus 1000. The power component 1006 may include a power management system, one or more power sources, and other components associated with the generation, management, and distribution of power in the apparatus 1000.

The multimedia component 1008 includes a screen providing an output interface between the apparatus 1000 and the user. In some embodiments, the screen may include a liquid crystal display (LCD) and a touch panel (TP). If the screen includes the touch panel, the screen may be implemented as a touch screen to receive input signal from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 1008 includes a front camera and/or a rear camera. The front camera and/or the rear camera may receive an external multimedia datum while the apparatus 1000 is in an operation mode, such as a photographing mode or a video mode. Each of the front camera and the rear camera may be a fixed optical lens system or have focus and optical zoom capability.

The audio component 1010 is configured to output and/or input audio signal. For example, the audio component 1010 includes a microphone (MIC) configured to receive external audio signal when the apparatus 1000 is in an operation mode, such as a call mode, a recording mode, and a voice identification mode. The received audio signal may be further stored in the memory 1004 or transmitted via the communication component 1016. In some embodiments, the audio component 1010 further includes a speaker to output audio signal.

The I/O interface 1012 provides an interface between the processing component 1002 and peripheral interface modules, such as a keyboard, a click wheel, a button, or the like. The button may include, but not limited to, a home button, a volume button, a starting button, or a locking button.

The sensor component 1014 includes one or more sensors to provide status assessments of various aspects of the apparatus 1000. For instance, the sensor component 1014 may detect an open/closed status of the apparatus 1000, relative positioning of components, e.g., the display and the keyboard, of the apparatus 1000, a change in position of the apparatus 1000 or a component of the apparatus 1000, a presence or absence of user contact with the apparatus 1000, an orientation or an acceleration/deceleration of the apparatus 1000, and a change in temperature of the apparatus 1000. The sensor component 1014 may include a proximity sensor configured to detect the presence of nearby objects without any physical contact. The sensor component 1014 may also include a light sensor, such as a CMOS or CCD image sensor, for use in imaging applications. In some embodiments, the sensor component 1014 may also include an accelerometer sensor, a gyroscope sensor, a magnetic sensor, a pressure sensor, or a temperature sensor.

The communication component 1016 is configured to facilitate communication, wired or wirelessly, between the apparatus 1000 and other apparatuses. The apparatus 1000 may access a wireless network based on a communication standard, such as WiFi, 2G, or 3G, or a set thereof. In one exemplary embodiment, the communication component 1016 receives broadcast signal or broadcast associated information from an external broadcast management system via a broadcast channel. In one exemplary embodiment, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1000 may be implemented with one or more application specific integrated circuits (ASICs), digital signal processors (DSPs), digital signal processing apparatuses (DSPDs), programmable logic apparatuses (PLDs), field programmable gate arrays (FPGAs), controllers, micro-controllers, microprocessors, or other electronic components, for performing the above method.

In exemplary embodiments, there is also provided a non-transitory computer readable storage medium including instructions, such as instructions included in the memory 1004, executable by the processor 1020 in the apparatus 1000, for performing the above method. For example, the non-transitory computer-readable storage medium may be a ROM, a random access memory (RAM), a CD-ROM, a magnetic tape, a floppy disc, an optical data storage apparatus, or the like.

One of ordinary skill in the art will understand that the above-described modules can each be implemented by hardware, or software, or a combination of hardware and software. One of ordinary skill in the art will also understand that multiple ones of the above-described modules may be combined as one module, and each of the above-described modules may be further divided into a plurality of sub-modules.

Other embodiments of the invention will be apparent to those skilled in the art from consideration of the specification and practice of the invention disclosed herein. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a smart device to access a router, comprising:
receiving an identifier of the smart device and an SSID of a router currently accessed by the smart device;
acquiring a set of SSIDs of routers corresponding to the identifier of the smart device;
determining whether the router currently accessed by the smart device is an access-prohibited router according to the SSID of the router currently accessed and the set of SSIDs of routers and obtaining a determined result; and
transmitting a corresponding instruction to the smart device according to the determined result.

2. The method according to claim 1, wherein the determining whether the router currently accessed by the smart device is an access-prohibited router according to the SSID of the router currently accessed and the set of SSIDs of routers, comprises:
if the set of SSIDs of routers is a set of SSIDs of access-prohibited routers and the SSID of the router currently accessed exists in the set of SSIDs of access-prohibited routers, determining the router currently accessed by the smart device as an access-prohibited router; or
if the set of SSIDs of routers is a set of SSIDs of access-permitted routers and the SSID of the router currently accessed does not exist in the set of SSIDs of access-permitted routers, determining the router currently accessed by the smart device as an access-prohibited router.

3. The method according to claim 1, wherein the transmitting a corresponding instruction to the smart device according to the determined result comprises:
if the router currently accessed by the smart device is an access-prohibited router, transmitting a reset instruction to the smart device, the reset instruction instructing the smart device to resume a state of being not connected with any router;
if the router currently accessed by the smart device is an access-prohibited router, transmitting a disconnect instruction to the smart device, the disconnect instruction instructing the smart device to disconnect from the router currently accessed; or
if the router currently accessed by the smart device is an access-prohibited router, transmitting a reconnect instruction to the smart device, the reconnect instruction instructing the smart device to disconnect from the router currently accessed and try to reconnect with another router.

4. The method according to claim 1, wherein the determining whether the router currently accessed by the smart device is an access-prohibited router according to the SSID of the router currently accessed and the set of SSIDs of routers and obtaining a determined result, comprises:
if the set of SSIDs of routers is a set of SSIDs of access-prohibited routers and the SSID of the router currently accessed does not exist in the set of SSIDs of access-prohibited routers, determining the router currently accessed by the smart device as an access-permitted router; or
if the set of SSIDs of routers is a set of SSIDs of access-permitted routers and the SSID of the router currently accessed exists in the set of SSIDs of access-permitted routers, determining the router currently accessed by the smart device as an access-permitted router.

5. The method according to claim 1, wherein the transmitting a corresponding instruction to the smart device according to the determined result comprises:
if the router currently accessed by the smart device is an access-permitted router, transmitting a connection holding instruction to the smart device, the connection holding instruction instructing the smart device to hold in a state of being connected with the router currently accessed.

6. The method according to claim 1, wherein, prior to the receiving an identifier of the smart device and an SSID of the router currently accessed by the smart device, the method further comprises:
receiving the identifier of the smart device and the set of SSIDs of routers corresponding to the identifier of the smart device; and
storing the identifier of the smart device and the set of SSIDs of routers corresponding to the identifier of the smart device.

7. A method for a smart device to access a router, comprising:
transmitting an identifier of the smart device and an SSID of the router to a server when the smart device accesses the router, the server being configured to determine whether the router currently accessed by the smart device is an access-prohibited router and to obtain a determined result;
receiving from the server a corresponding instruction generated according to the determined result; and
performing a corresponding process according to the corresponding instruction.

8. The method according to claim 7, wherein the performing a corresponding process according to the corresponding instruction comprises:
resuming a state of being not connected with any router if the instruction is a reset instruction;
disconnecting from the router currently accessed if the instruction is a disconnect instruction;
disconnecting from the router currently accessed and trying to connect with another router if the instruction is a reconnect instruction; and
holding a connection with the router currently accessed if the instruction is a connection hold instruction.

9. An apparatus for a smart device to access a router, comprising:
a processor; and
a memory for storing instructions executable by the processor, wherein the processor is configured to:
receive an identifier of the smart device and an SSID of a router currently accessed by the smart device;
acquire a set of SSIDs of routers corresponding to the identifier of the smart device;
determine whether the router currently accessed by the smart device is an access-prohibited router according to the SSID of the router currently accessed and the set of SSIDs of routers and obtain a determined result; and
transmit a corresponding instruction to the smart device according to the determined result.

10. The apparatus according to claim 9, wherein the processor is further configured to:
if the set of SSIDs of routers is a set of SSIDs of access-prohibited routers and the SSID of the router currently accessed exists in the set of SSIDs of access-prohibited routers, determine the router currently accessed by the smart device as an access-prohibited router; or
if the set of SSIDs of routers is a set of SSIDs of access-permitted routers and the SSID of the router currently accessed does not exist in the set of SSIDs of access-permitted routers, determine the router currently accessed by the smart device as an access-prohibited router.

11. The apparatus according to claim 9, wherein the processor is further configured to:
if the router currently accessed by the smart device is an access-prohibited router, transmit a reset instruction to the smart device, the reset instruction instructing the smart device to resume a state of being not connected with any router;
if the router currently accessed by the smart device is an access-prohibited router, transmit a disconnect instruction to the smart device, the disconnect instruction instructing the smart device to disconnect from the router currently accessed; or
if the router currently accessed by the smart device is an access-prohibited router, transmit a reconnect instruction to the smart device, the reconnect instruction instructing the smart device to disconnect from the router currently accessed and try to reconnect with another router.

12. The apparatus according to claim 9, wherein the processor is further configured to:
if the set of SSIDs of routers is a set of SSIDs of access-prohibited routers and the SSID of the router currently accessed does not exist in the set of SSIDs of access-prohibited routers, determine the router currently accessed by the smart device as an access-permitted router; or
if the set of SSIDs of routers is a set of SSIDs of access-permitted routers and the SSID of the router currently accessed exists in the set of SSIDs of access-permitted routers, determine the router currently accessed by the smart device as an access-permitted router.

13. The apparatus according to claim 9, wherein the processor is further configured to:
if the router currently accessed by the smart device is an access-permitted router, transmit a connection holding instruction to the smart device, the connection holding instruction instructing the smart device to hold in a state of being connected with the router currently accessed.

14. The apparatus according to claim 9, wherein, prior to the receiving an identifier of the smart device and an SSID of the router currently accessed by the smart device, the processor is further configured to:
receive the identifier of the smart device and the set of SSIDs of routers corresponding to the identifier of the smart device; and
store the identifier of the smart device and the set of SSIDs of routers corresponding to the identifier of the smart device.

15. An apparatus for a smart device to access a router, comprising:
a processor; and
a memory for storing instructions executable by the processor, wherein the processor is configured to:
transmit an identifier of the smart device and an SSID of the router to a server when the smart device accesses the router, the server being configured to determine whether the router currently accessed by the smart device is an access-prohibited router and obtain a determined result;
receive from the server a corresponding instruction generated according to the determined result; and
perform a corresponding process according to the corresponding instruction.

16. The apparatus according to claim 15, wherein the processor is further configured to:
resume a state of being not connected with any router if the instruction is a reset instruction;
disconnect from the router currently accessed if the instruction is a disconnect instruction;
disconnect from the router currently accessed and try to connect with another router if the instruction is a reconnect instruction; and
hold a connection with the router currently accessed if the instruction is a connection hold instruction.
